(19) United States
(12) Patent Application Publication
(10) Pub. No.: US 2015/0056369 A1
(43) Pub. Date: Feb. 26, 2015

(54) SURVEYING SYSTEM AND MARKING DEVICE

(71) Applicant: Brandon Kohn, West Bend, WI (US)

(72) Inventor: Brandon Kohn, West Bend, WI (US)

(21) Appl. No.: 13/973,565

(22) Filed: Aug. 22, 2013

(51) Int. Cl. G01C 15/04; G01C 15/06

(52) U.S. Cl. CPC G01C 15/04; G01C 15/06
USPC 427/137; 702/5; 239/289

(57) ABSTRACT

A system and method for creating and storing a trace of a surveyed area is provided. The system includes a marking device that is moved along the outer perimeter of an area to be surveyed. A tablet computer of the marking device communicates with a surveying station and stores defined points along the survey trace. Once the survey trace is completed, the tablet computer of the marking device generates a calculation of the surface area and a cost estimate for covering the surface area with various materials. The trace is stored within the tablet computer such that the marking device can be utilized to re-mark the surface trace at a later date. The marking device includes a spray unit that is automatically activated by the tablet computer to generate markings along the survey trace.

### BACKGROUND

The present disclosure relates to a system and method for accurately measuring and marking a survey area. More specifically, the present disclosure relates to a device that can be used to create and store a trace for a survey area and, at a later date, mark the previously surveyed area.

Presently, surveying systems are available that can be used to measure distances, horizontal angles and vertical angles at a survey location. The surveying systems currently available include a tracking function that allows a surveying station to track the movement of a target around an area to be surveyed. As an example, the target can include reflectors mounted on a pole that is moved along the area to be surveyed. The surveying station tracks the movement of the target and creates various tracking points along the surveyed area.

Although surveying devices that include a tracking function are known, these devices are limited in their application and usefulness on a small scale basis.

### SUMMARY

The present disclosure relates to a marking device for use with a surveying station. The marking device is movable along an outer perimeter of an area to be surveyed. The marking device includes a support body that provides a point of attachment and support for a tablet computer. The tablet computer includes a display, and preferably a touch display, although other types of computing devices are contemplated. The tablet computer is in wireless communication with the surveying station such that the tablet computer can receive information from the surveying station.

The marking device further includes a target device that is mounted to the support body. In one embodiment of the disclosure, the target device includes a 360° prism that reflects light or a laser from the surveying station. The reflected light from the target device is received at the surveying station such that the surveying station can accurately determine the position of the target device relative to the surveying station. Since the tablet computer and the surveying station communicate with each other, the detected positions of the target device can be displayed on the tablet computer.

The marking device further includes a spray unit that is mounted to the support body and is in operative communication with the tablet computer. The tablet computer is programmed such that the tablet computer controls the operation of the spray unit. As an illustrative example, the tablet computer can activate an actuator of the spray unit to control the discharge of a spray, such as spray paint. In this manner, the tablet computer is able to mark locations on the ground that define a survey trace.

The present disclosure also relates to a method of surveying an area. The method of surveying the area includes positioning a surveying station at a reference location relative to the area to be surveyed. Once the surveying station is positioned, a marking device is positioned along a portion of the area to be surveyed. Once positioned, a tablet computer of the marking device is activated such that the tablet computer is wireless communication with the surveying station. Once the wireless communication has been established, the marking device is moved along the perimeter of the area to be surveyed. The surveying station detects the movement of the marking device through a target device contained as part of the marking device. The surveying station calculates the position of the marking device and relays the detected positions to the tablet computer. When the tablet computer receives the detected positions of the marking device, the tablet computer creates a survey trace, which is stored in the memory of the tablet computer. The survey trace defines the outer perimeter of the area that has been surveyed utilizing the combination of the marking device and the surveying station.

Once the survey trace has been created and stored, the tablet computer calculates an area that is defined by the survey trace. The tablet computer includes an internal program that is able to calculate the surface area defined by the survey trace. Typically, the surface area is defined by a square footage, although other measurement values are contemplated.

After the area defined by the survey trace has been calculated, the calculated area is displayed to the user on the display of the tablet computer. Since the area defined by the survey trace is known, the tablet computer is able to create cost estimates for covering the area using different types of materials. As an example, the tablet computer can generate a cost estimate for covering the surface area with asphalt, concrete, crushed gravel or mulch. These cost estimates are selectively shown to the operator.

In addition to calculating the surface area, the method of the present disclosure can be utilized to mark the survey trace at a date after the survey trace was created. To mark the survey trace on the ground, the method requires the surveying station to be placed at a reference location. In one embodiment of the disclosure, the surveying station includes a GPS locator. Since the surveying station includes a GPS locator, the surveying station does not need to be placed in the exact same position as when the survey trace was created. In another embodiment in which the surveying station does not include a GPS locator, two or more fixed points are defined at the survey location and the surveying station re-calculates measurements based on these fixed positions. Once the surveying station is placed, the tablet computer of the marking device is activated and the marking device is moved toward the survey area. The tablet computer and the surveying station communicate with each other such that the relative position of the survey trace and the marking device are shown on the display of the tablet computer. Based upon the display, the operator is then able to move the marking device toward the survey trace.

Once the marking device reaches the survey trace, the tablet computer automatically activates the spray unit to place a mark on the ground. The mark generated on the ground indicates the outer perimeter of the survey trace. The tablet computer prompts the user to move the marking device along the outer perimeter of the surveyed area, at which time the tablet computer automatically operates the spray unit to place additional marks on the ground to define the stored trace. In this manner, the combination of the surveying station and marking device are able to automatically regenerate the survey trace.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view illustrating the initial surveying of an area utilizing a surveying station and a marking device constructed in accordance with the present disclosure;

FIG. 2 is a schematic illustration showing the interaction between the surveying station and the marking device;

FIG. 3 is an illustration showing the marked survey area for a home;

FIG. 4 is a graphic illustration of a display included on a tablet computer of the marking device;

FIG. 5 illustrates the mechanical spray unit used to mark physical locations;

FIG. 6 is a flowchart describing the method of determining the surface area being surveyed;

FIG. 7 is a flowchart illustrating the method of marking the previously surveyed area; and

FIG. 8 is a partial display showing the position of the marking device relative to the reference station.

### DETAILED DESCRIPTION

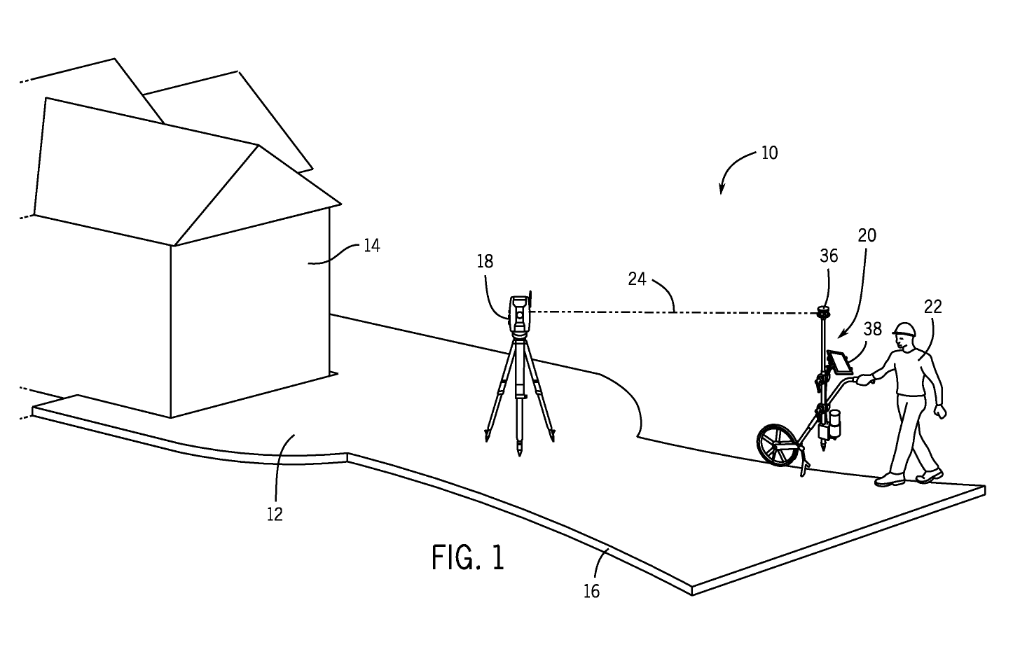

FIG. 1 illustrates a system 10 that can be used to survey an area 12 such that the cost of covering the area 12 with material, such as concrete or asphalt, can be calculated. In the embodiment shown in FIG. 1, the area 12 to be surveyed represents a driveway that the owner of the home 14 desires to have paved or resurfaced. In the embodiment shown in FIG. 1, the area 12 has an irregular outer perimeter 16 such that the calculation of the area defined by the perimeter 16 cannot simply be calculated by measuring a length and a width.

As illustrated in FIG. 1, the system 10 includes a surveying station 18 that is positioned at a reference point within the area 12. Although the reference point is shown within the area 12, the reference point could be located outside of the area 12. The system 10 further includes a marking device 20 that can be moved along the outer perimeter 16 by a contractor 22. The surveying station 18 detects the movement of the marking device 20 through a series of light waves 24 that are reflected by the marking device 20 and received back at the surveying station 18. In one embodiment of the disclosure, the surveying station 18 includes a GPS locator, which allows the exact position of the surveying station 18 and the marking device 20 to be determined as the marking device is moved relative to the surveying station 18. Alternatively, different models of the surveying station can be used that do not include an internal GPS locator. In such embodiments, fixed points at the survey area are used as reference points.

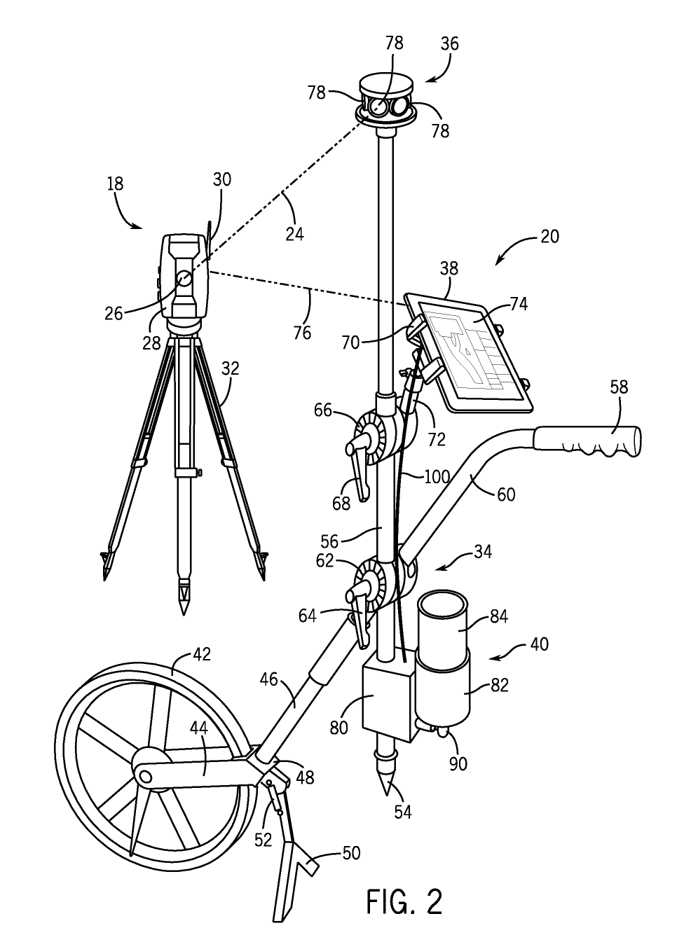

FIG. 2 provides a more detailed view of the both the surveying station 18 and the marking device 20. The surveying station 18 is a currently available surveying station that emits a distance measuring light waves 24 from an image pickup unit 26. The light received at the image pickup unit 26 is used to determine the relative position of the reflecting device and is recorded within a control unit contained within the main body 28. In the embodiment shown, the main body 28 includes an external antenna 30 such that an internal GPS unit contained within the main body can accurately determine the position of the surveying station. Since the precise GPS location of the surveying station 18 is known within the control unit, the surveying station 18 defines a reference point for which measured points along the perimeter of the surveyed area can be compared.

The main body 28 is supported by a tripod 32 having legs that can be independently adjusted. The tripod 32 allows the main body 28 to be leveled such that the surveying station 18 not only defines a point in a GPS coordinate system, but also defines a vertical position in space. The vertical position in space defined by the surveying station can not only be used to define the outer perimeter of the surveyed area, but can also determine the relative vertical location of points along the surveyed area.

An example of a commercially available surveying station 18 that could be utilized in accordance with the present disclosure is the Trimble Robotic Total Station S3, available from Trimble.

The marking device 20 constructed in accordance with the present disclosure allows the surveying station 18 to accurately track the movement of the marking device 20 around the outer perimeter of the area to be surveyed. The marking device includes a support body 34 that provides mounting locations for the remaining components of the marking device 20. The support body 34 supports a target device 36, a tablet computer 38 and a spray unit 40. The support body 34 is movable along the ground through a support wheel 42. The support wheel 42 is rotatable within a fork 44 mounted to a telescoping lower pole 46. The top end 48 of the fork 44 supports a guide member 50. The guide member 50 is a V-shaped member that is resiliently mounted to the fork 44 through a spring member 52. The guide member 50 and contacts the ground as the marking device 20 is moved along the perimeter of the area being surveyed. The V-shaped guide member 50 is generally aligned with the point 54 of the vertical support pole 56. The point 54 is located approximately four to six inches above the ground when the marking device 20 is moved along the perimeter of the area being surveyed.

The support body 34 further includes a handle 58 mounted to a handle tube 60. The orientation of the handle tube 60 relative to the support pole 56 can be adjusted through an adjustment mechanism 62 that includes a release handle 64. The adjustment mechanism 62 and the release handle 64 allows the handle 58 and tube 60 to be adjusted depending upon the size of the operator.

The tablet computer 38 is securely mounted to the vertical support pole 56 through a second adjustment mechanism 66 having a similar adjustment handle 68. A tablet support bracket 70 is mounted to the adjustment mechanism 66 through a support arm 72. The tablet support bracket 70 is adjustable to securely hold and orient the tablet computer 38. In the present disclosure, the tem “tablet computer” is meant to refer to any type of computing device that includes a display screen 74 that is used for both displaying information and as a touchpad for user interface. Examples of currently available tablet computer include a Galaxy® II Tablet available from Samsung and the iPad® available from Apple Computers. It is contemplated that various different types of computers will be developed that can be utilized with the marking device 20 of the present disclosure.

The tablet computer 38 includes wireless communication capabilities such that the tablet computer 38 can communicate wirelessly to the surveying station 18 over the wireless communication link 76. Various different types of wireless communication techniques are contemplated as being within the scope of the present disclosure. Examples of these wireless communication techniques include Bluetooth® and Wi-Fi. The wireless communication link 76 preferably has a range of approximately 200 feet such that the table computer 38 can receive information from the surveying station 18 as the marking device 20 is moved around the outer perimeter of the area being surveyed.

The vertical support pole 56 supports the target device 36. In the embodiment illustrated, the target device 36 is a 360° prism having multiple reflectors 78 located around the entire outer circumference of the target device 36. The 360° prism including the multiple reflectors 78 allows the target device 36 to reflect the light waves 24 generated by the surveying station 18 such that reflective light rays are received at the surveying station 18. In this manner, the surveying station 18 is able to accurately determine the position of the marking device 20 relative to the surveying station 18 as the marking device 20 is moved around the outer perimeter of the area being surveyed.

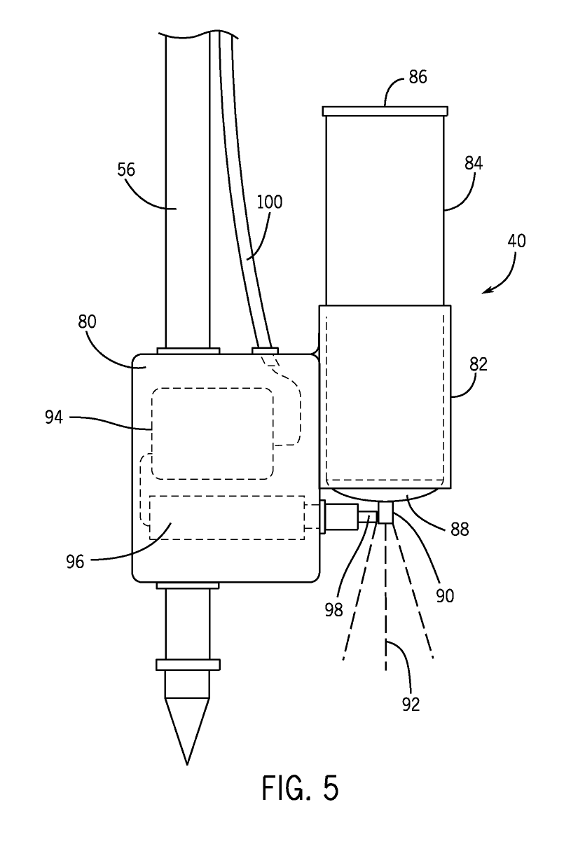

FIGS. 2 and 5 illustrate the spray unit 40 mounted on the support pole 56. The spray unit 40 includes a main housing 80 that is securely mounted to the support pole 56. The main housing 80 in turn supports a spray holder 82 that receives and retains a spray applicator 84. In the embodiment shown in FIG. 5, the spray applicator 84 is a can of spray paint having a bottom end 86 and a top end 88 including a spray nozzle 90. When depressed, the nozzle 90 emits a spray pattern 92. The spray pattern 92 can be used to mark a location on the ground.

The housing 80 encloses a power supply 94 and an actuator 96. The actuator 96 is preferably a solenoid having a plunger 98 that is selectively movable into and out of engagement with the nozzle 90. The activation of the actuator 96 thus controls the discharge of spray paint from the nozzle 90 of the spray applicator 84. The power supply 94 is preferably a rechargeable battery that provides power to extend and retract the plunger 98 of the actuator 96.

A control cable 100 extends into the housing 80 and is in operative communication with the power supply 94, as illustrated. The control cable 100 is connected to the table computer 38 such that the tablet computer 38 can control the activation of the actuator 96 through the control cable 100. Specifically, when the tablet computer 38 wishes to mark a spot on the ground, the tablet computer 38 sends a signal through the control wire 100 that causes power to be supplied from the power supply 94 to the actuator 96, thereby causing paint to be discharged from the nozzle 90. Although the control cable 100 is shown in the preferred embodiment, it is contemplated that the tablet computer 38 could communicate wirelessly to the spray unit 40.

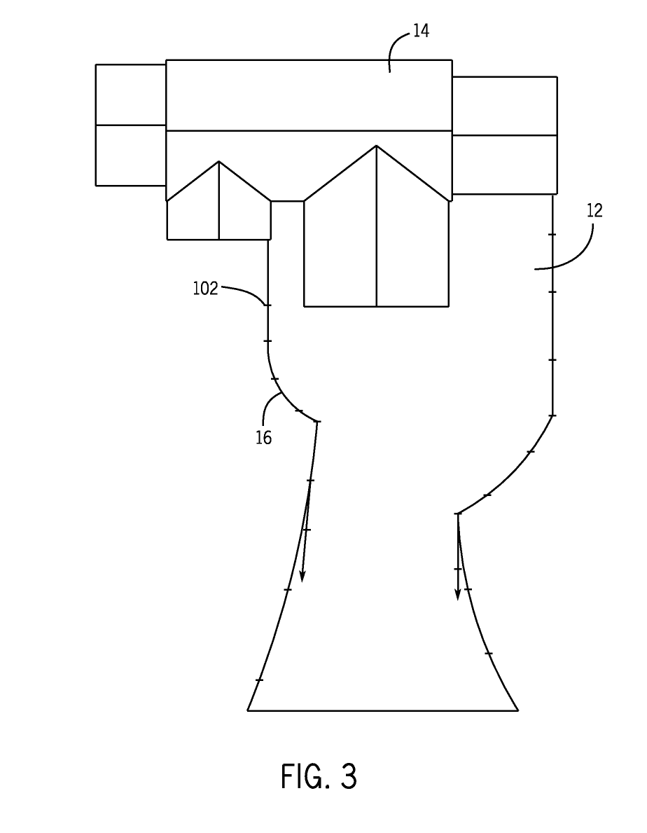

FIG. 3 is a schematic illustration of the surveyed area 12 relative to the home 14. The surveyed area 12 includes a series of marked locations 102 that define the outer perimeter 16. Each of the marked locations 102 is stored in the memory of the tablet computer as a distinct GPS location. These locations are determined by the surveying station and wirelessly transferred to the tablet computer 38. Since the tablet computer includes memory, the entire outer perimeter 16, as defined by the multiple marked locations 102, is stored in the memory of the table computer as a survey trace.

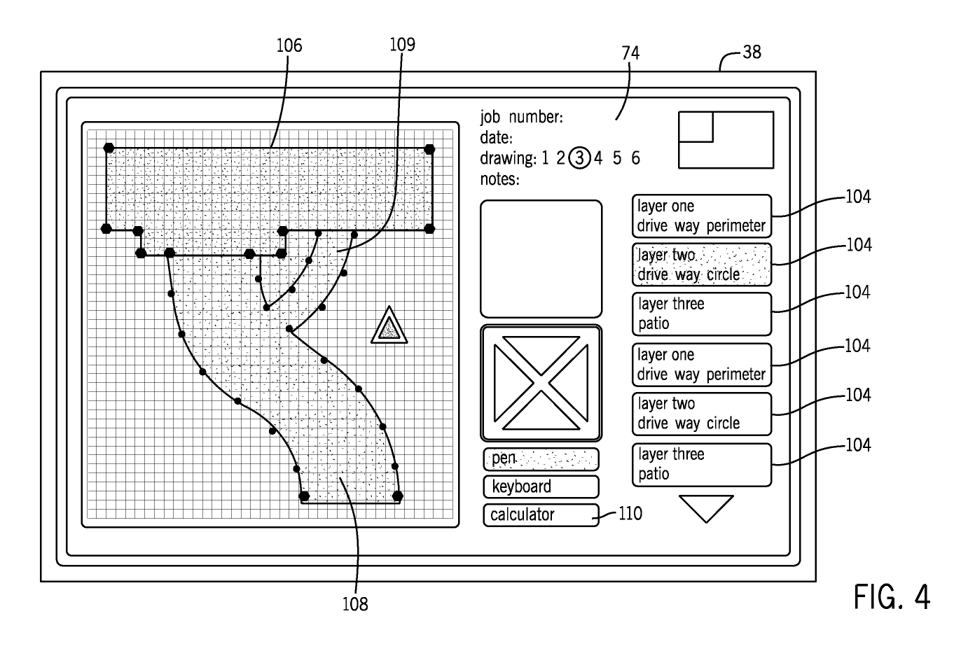

FIG. 4 illustrates the display 74 of the tablet computer. Since the tablet computer 38 includes a touch display, the contractor can retrieve information from the tablet computer through a series of visually displayed buttons 104. The buttons 104 allow the user to select different stored traces for an area. In the embodiment shown in FIG. 4, there is a stored trace for a patio 106 and a driveway 108. Both the patio 106 and the driveway 108 are defined by multiple stored points that are shared through wireless communication between the surveying station and the marking device. Each of the survey traces are stored in the tablet computer and can be retrieved by an operator at any time.

As illustrated in FIG. 4, the display 74 includes a calculator button 110. When the calculator button 110 is selected, the tablet computer 38 calculates the area within the selected trace. In the embodiment shown, the selected trace is the driveway 108. In the embodiment shown in FIG. 4, the trace for the driveway 108 has an irregular surface area and includes a walkway 109. The tablet computer 38 includes a stored program that is able to estimate the area defined by the outer perimeter of the survey trace. The program stored on the tablet computer to calculate the surface area defined by the survey trace is well known to those of ordinary skill in the art and the details of which are not set forth herein. The program used to calculate the surface area generates an area calculation in the desired measurement values in a conventional measurement parameter, such as square feet. In this manner, the tablet computer 38 is able to calculate the area within the driveway based on the survey trace.

Although not shown, once the calculated area is shown, the contractor can retrieve or enter a cost of multiple different materials per square foot. As an example, concrete may cost $3.55 per square foot, asphalt may cost $2.95 per square foot and crushed gravel may cost $1.05 per square foot. In this manner, the contractor is able to provide the homeowner multiple estimates for covering the surveyed area with any one of multiple different materials.

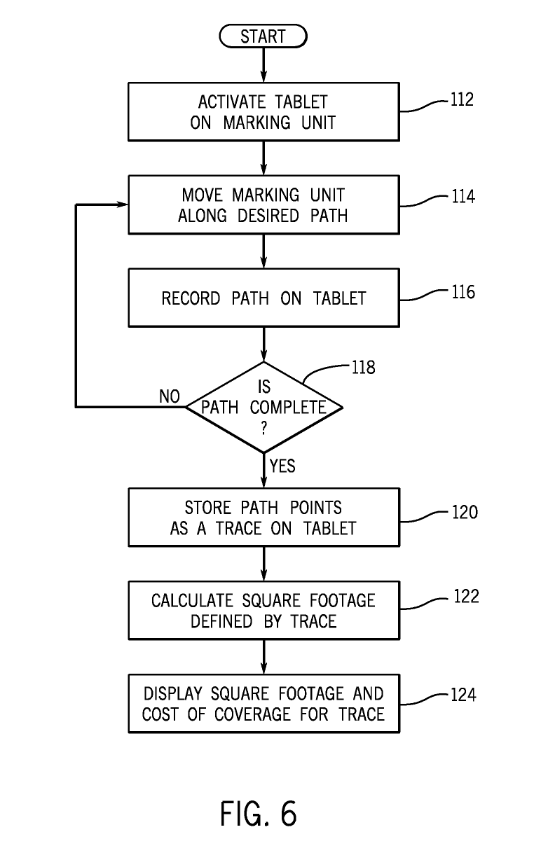

FIG. 6 provides a flowchart of one method of utilizing the marking device 20 to create a stored survey trace within the tablet computer 38. Initially, when it is desired to survey an area, the marking device 20 is moved into a position along the outer perimeter 16, as shown in FIG. 1. Once the marking device 20 is in position, the tablet computer 38 is activated, as shown in step 112 of FIG. 6. Once the tablet is activated, the tablet computer 38 begins wireless communication with the surveying station 18. The surveying station 18 operates to emit light waves 24 that are reflected by the target device 36, as illustrated in FIG. 1.

Once the surveying station 18 and the tablet computer 38 begin to communicate with each other, the marking device 20 is moved along the outer perimeter 16, as shown in step 114. As the marking device is moved along the outer perimeter, the surveying station 18 and the marking device 20 continue to communicate with each other such that the survey path is both displayed and recorded on the tablet computer 38, as indicated in step 116. During the recording of the survey path, the user is able to indicate whether or not the path is complete, as indicated in step 118. If the path is not complete, the system returns to step 114 and continues to record various locations along the path.

Once the user indicates that the survey path has been completed, all of the path points are stored as a complete survey trace on the tablet, as indicated in step 120. A complete survey trace defines a path taken by the marking device, as is illustrated in FIG. 3.

Referring back to FIG. 6, once the entire survey trace has been stored on the tablet computer, the tablet computer calculates the square footage that is defined by the trace, as indicated in step 122. Since the survey trace is stored on the tablet computer, the tablet computer is programmed such that the tablet computer itself can calculate the square footage defined by the trace. Since the trace and the area calculation program are both stored on the tablet computer, the tablet computer can calculate the square footage almost instantaneously once the user indicates that the path is complete in step 118. In this manner, the operator/contractor is able to provide the homeowner/customer with an accurate and immediate estimate of the surface area to be covered.

As shown in step 124, the tablet computer cannot only display the square footage but also can calculate the cost for covering the square footage defined by the trace. In step 124, the operator can either manually enter or retrieve different costs for materials used to cover the square footage defined by the trace. As an example, the operator can select costs for asphalt, concrete, brick pavers, stamped concrete, gravel, or mulch. Since the tablet computer almost instantly calculates the square footage, the costs for each of these different materials can also be determined on site and presented to the homeowner. If the cost estimates are too high or less than anticipated, the contractor could modify the survey trace to decrease the surface area or modify the trace to increase the surface area. Since the contractor is still on site, the immediate estimate of the cost to cover an area can be presented to the homeowner and the trace modified without having to set up another appointment for the contractor to return to the work site.

As indicated in FIG. 6, once the survey trace has been completed, the locations for each of the recorded points and the entire survey trace are stored on the tablet. The trace includes GPS locations for each point along the stored trace. Since the process of initially generating the survey trace and cost estimates often occurs days or weeks before beginning the work needed to cover the area is completed, the tablet computer stores the trace on the tablet for later use. As an example, the homeowner may take several weeks to authorize the construction and the contractor will then return to the job site several weeks or months after the initial survey has been completed.

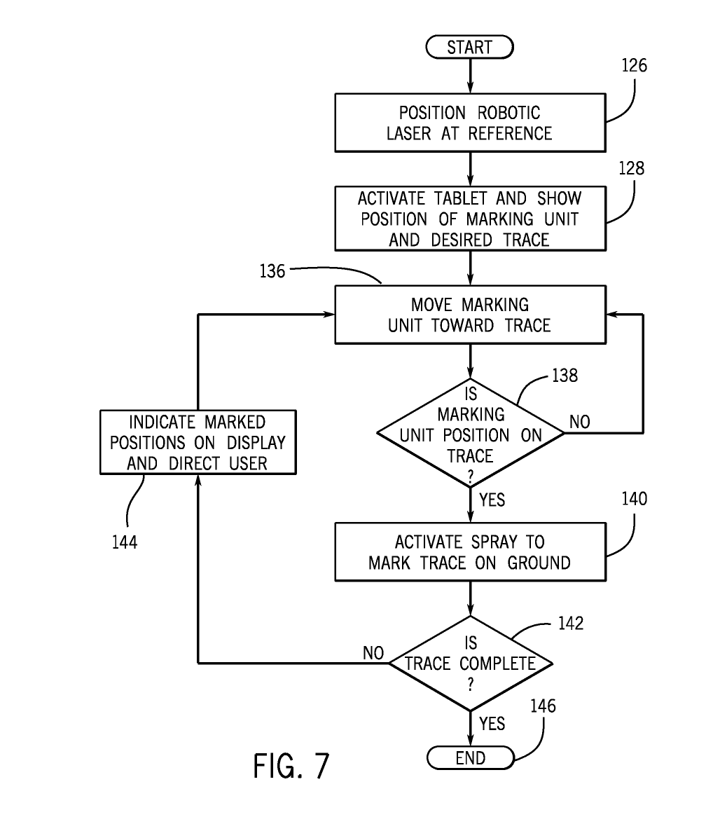

The interaction between the surveying station 18 and the marking device 20 also allows the contractor to mark the survey trace on the ground in the manner shown by the flowchart in FIG. 7. Initially, the contractor positions the surveying station at a reference location, as indicated by step 126. Since the surveying station 18 in the illustrated embodiment includes a GPS unit, the surveying station 18 does not need to be placed in the exact location used to initially generate the survey trace. Instead, the survey station can be placed at any location near the survey site and the survey station calculates its location relative to the position used to create the initial trace. In an alternate embodiment in which the surveying station 18 does not include a GPS unit, the location of the surveying station 18 is calibrated to two or more fixed locations at the surveying site. Based on these fixed positions, the surveying station 18 can determine its position and subsequently the position of the previously located areas on the survey trace.

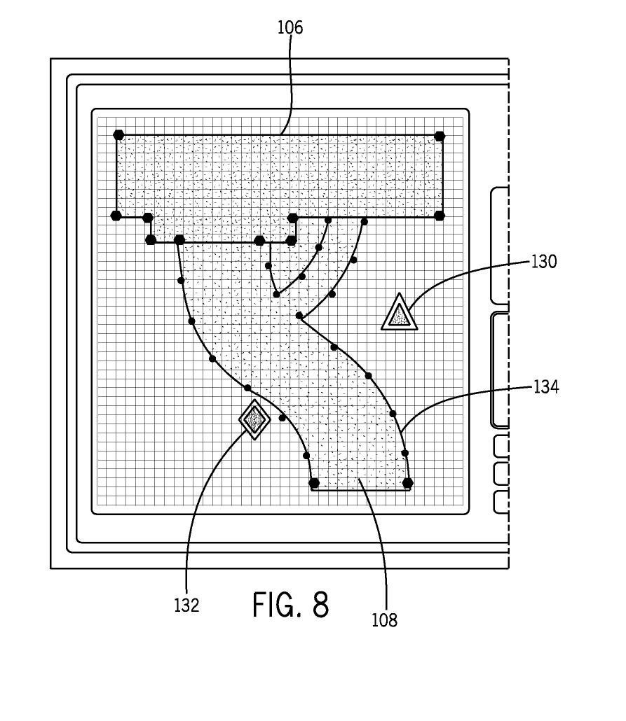

Once the survey station has been placed, the tablet computer is activated. Once activated, the survey trace for the area to be marked is retrieved from memory on the tablet computer and is displayed, as shown in FIG. 8 and described in step 128. In addition to the trace for both the patio 106 and the driveway 108, the display also includes an indicator showing the position of the surveying station, as indicated by reference symbol 130. In addition to the reference symbol, the display also includes an indicator 132 of the current location of the marking device. The indicator 132 thus shows the location of the marking device relative to the outer trace 134 of the driveway 108.

Referring back to FIG. 7, the system directs the contractor to move the marking device toward the trace in step 136. Since the surveying station 18 and the tablet computer 38 are in constant communication with each other, the tablet computer determines in step 138 whether the marking device is at a location along the survey trace 134. If the marking device is not on the trace 134, the display on the tablet computer 38 indicates to the contractor to move closer to the trace. The visual display shown in FIG. 8 allows the contractor to view his location relative to the trace 134 and move accordingly.

If the tablet computer determines in step 138 that the marking device is on the race, the tablet computer sends a signal along the control cable to activate the actuator and discharge spray through the nozzle of the spray container, as indicated in step 140. Since the activation of the spray container is controlled by the tablet computer, the operator does not need to take any steps to mark the location of the outer perimeter. Instead, the tablet computer 38 takes care of the marking and only places markings at precise locations along the stored survey trace.

In step 142, the tablet computer determines whether the entire trace has been completed. If the entire trace has not been completed, the system indicates the marked positions on the display, as shown in FIG. 8, and directs the user to continue to move along the unmarked portions of the trace, as indicated in step 144.

The steps continue until the system determines in step 142 that the entire trace has been marked on the ground. Once the entire trace has been marked, the process ends, as shown in step 146.

Although the operational steps shown in FIG. 6 do not discuss marking the survey path when the path is initially traced, it is contemplated that the tablet computer 38 could be configured to actuate the spray unit to place markings on the outer perimeter. The markings placed on the outer perimeter can be spaced by a desired distance to provide a visual indication to the contractor and homeowner of the size of the surveyed area. In addition, it is contemplated that the display on the tablet computer could be configured to have a manual activation button that allows the operator to manually activate the spray applicator to place a mark on the ground during the surveying process.

As can be understood by the above description and drawing Figures, the system of the present disclosure allows a contractor to initially trace the outer perimeter of a surveyed area and store the trace in a tablet computer. Once the trace has been stored, the contractor can calculate the square footage of the area defined by the outer trace and provide cost estimates for various different types of materials to cover the surface area. Since the survey trace is stored within the tablet computer, the contractor can return to the work site at a later time and utilize the marking device to automatically mark the same surface trace. This ability to re-mark the trace by utilizing the marking device and a survey station reduces the amount of time needed to prepare a work site prior to covering a surface area.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A marking device for use with a surveying station, comprising:
a support body;
a tablet computer mounted to the support body, the tablet computer haying a display;
a target device mounted to the support body; and
a spray unit mounted to the support body and in operative communication with the tablet computer such that the tablet computer controls the operation of the spray unit.

2. The marking device of claim 1 wherein the spray unit includes a spray applicator and an actuator, wherein the operation of the actuator is controlled by the tablet computer.

3. The marking device of claim 2 wherein the spray unit further includes an internal power supply coupled to the actuator.

4. The marking device of claim 1 wherein the spray applicator is a can of spray paint.

5. The marking device of claim 1 wherein the mobile computer communicates with the surveying station utilizing wireless communication.

6. The marking device of claim 1 further comprising a measuring wheel mounted to the support body for movement of the support body along the ground.

7. The marking device of claim 1 wherein the target device is a 360° prism.

8. A method of surveying an area, comprising the steps of:
positioning a surveying station at a reference location;
positioning a marking device along a portion of the area to be surveyed;
activating a tablet computer of the marking device, wherein the tablet computer is in wireless communication with the surveying station;
moving the marking device along a perimeter of the area to be surveyed;
displaying a path of movement of the marking device on a display of the tablet computer;
calculating an area defined by the path of movement in the tablet computer; and
displaying the calculated area on the tablet computer.

9. The method of claim 8 further comprising the steps of:
selecting a material type for the calculated area;
calculating a cost estimate for covering the calculated area with the selected material; and
displaying the cost estimate on the tablet computer.

10. The method of claim 8 wherein the marking device includes a target device that is detected by the surveying station.

11. The method of claim 10 wherein the surveying station communicates the detected position of the target device to the tablet computer.

12. The method of claim 8 wherein the path of movement of the marking device is displayed in real time with the movement of the marking device.

13. The method of claim 8 further comprising the step of storing the path of movement on the tablet computer as a survey trace.

14. A method of marking a surveyed area comprising the steps of:
positioning a surveying station at a reference location;
positioning a marking device near the surveyed area;
retrieving a stored trace of the surveyed area from a tablet computer of the marking device;
displaying the stored trace and a current position of the marking device on the display of the tablet computer;
moving the marking device along the displayed stored trace; and
activating a spray unit of the marking device to mark the stored trace on the ground.

15. The method of claim 14 wherein the tablet computer automatically activates the spray unit to mark the stored trace on the ground when the marking device is located along the stored trace.

16. The method of claim 15 wherein the spray unit includes a spray applicator and an actuator, wherein the tablet computer activates the actuator.

17. The method of claim 14 wherein the tablet computer receives the current position of the marking device from the survey station through wireless communication.

18. The method of claim 14 wherein the stored trace is retrieved from the tablet computer.
